(19) United States
(12) Patent Application Publication
(10) Pub. No.: US 2007/0053174 A1
(43) Pub. Date: Mar. 8, 2007

(54) Fountain

(76) Inventor: Chung-Kuei Lin, Hsinchuang City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/221,273

(22) Filed: Sep. 7, 2005

(51) Int. Cl. F21V 33/00

(52) U.S. Cl. 362/96; 362/101; 362/234

(57) ABSTRACT

A fountain has a base, a pump, a lighting device and at least one stand. The base holds liquid and has a top opening. The at least one stand is mounted on the top opening of the base and has a top. The pump is mounted inside the base and is connected to the stand. The lighting device is mounted on the top of the stand. When liquid flows through the lighting device, the light from the lighting device is reflected the liquid and enhances the optical appearance by making the flowing liquid look like a candle flame. The lighting device can make the fountain easy and safe to use.

### BACKGROUND OF THE INVENTION

1. Field of the Invention

The present invention relates to a fountain, and more particularly to a fountain that is able to function as a candle fountain.

2. Description of Related Art

With reference to FIG. 4, a conventional candle fountain comprises a base (6), a cover (7) and a stand (8). The base (6) is hollow and has a top opening, a bottom, a pump (61) and a shoulder (62). The top opening has an edge. The shoulder (62) is formed inside the base (6) near the edge of the top opening. The pump (61) is mounted on the bottom of the base (6).

The cover (7) has edges, a central hole and multiple drain holes (71). The edges of the cover (7) are mounted on the shoulder (62) of the base (6) to mount the cover (7) on the base (6). The central hole is formed through the cover (7). The drain holes (71) are formed through the cover (7).

The stand (8) is mounted on the cover (7) and has a top surface, at least one candle recess (81) and at least one water passage (82). The candle recess (81) is formed on the top surface of the stand (8) and holds a candle (83). The water passage (82) is formed through the stand (8) and has an upper side opening and a bottom opening. The bottom opening of the water passage (82) connects to the pump (61) through the central hole in the cover (7).

The base (6) holds water. When the candle (83) in the candle recess (81) of the stand (8) is burning, the pump (61) pumps water to the water passage (82) through the bottom opening in the water passage (82). The water is discharged from the water passage (82) through the upper side opening. Light from the burning candle (83) is reflected in the water. The water flows downwardly along the stand (8) to the cover (7) and drains back into the base (6).

However, the candle (83) can be troublesome. For example, the candle (83) periodically needs to be replaced and needs to be lighted each time the candle fountain is used. The lighted candle (83) also is a fire hazard that could lead to disaster. The candle fountain is not convenient to use.

To overcome the shortcomings, the present invention provides a fountain to obviate or mitigate the aforementioned problems.

### SUMMARY OF THE INVENTION

The primary objective of the present invention is to provide a fountain that is safe and convenient to use.

The fountain has a base, a pump, a lighting device and at least one stand. The base holds liquid and has a top opening. The at least one stand is mounted on the top opening of the base and has a top. The pump is mounted inside the base and is connected to the stand. The lighting device is mounted on the top of the stand. When liquid flows through the lighting device, light from the lighting device is reflected in the liquid and enhances the optical appearance by making the flowing liquid look like a candle flame. The lighting device can make the fountain easy and safe to use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a fountain in accordance with the present invention;

FIG. 2 is an exploded perspective view of the fountain in FIG. 1;

FIG. 3 is a side view in partial section of the fountain in FIG. 1; and

FIG. 4 is a side view in partial section of a conventional candle fountain in accordance with the prior art.

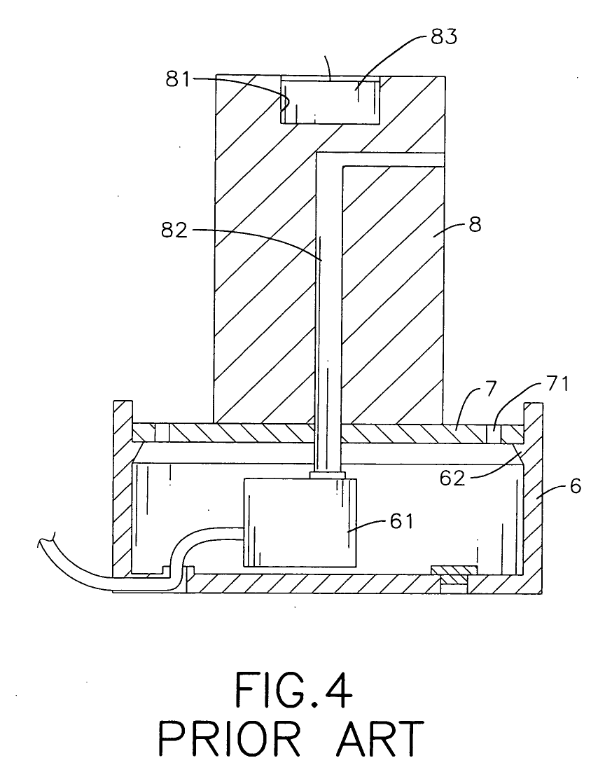

### DETAILED DESCRIPTION OF THE PREFERRED EMBODIMENT

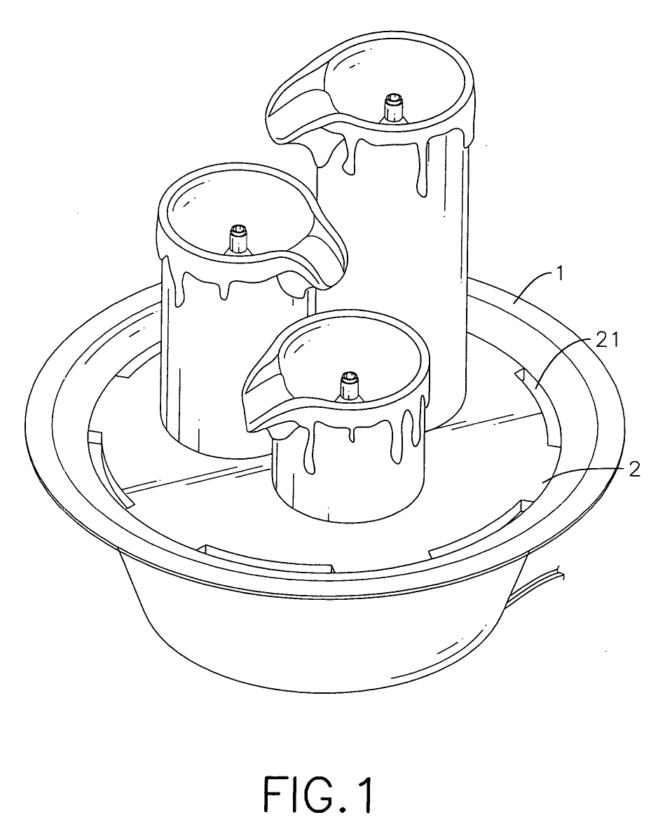

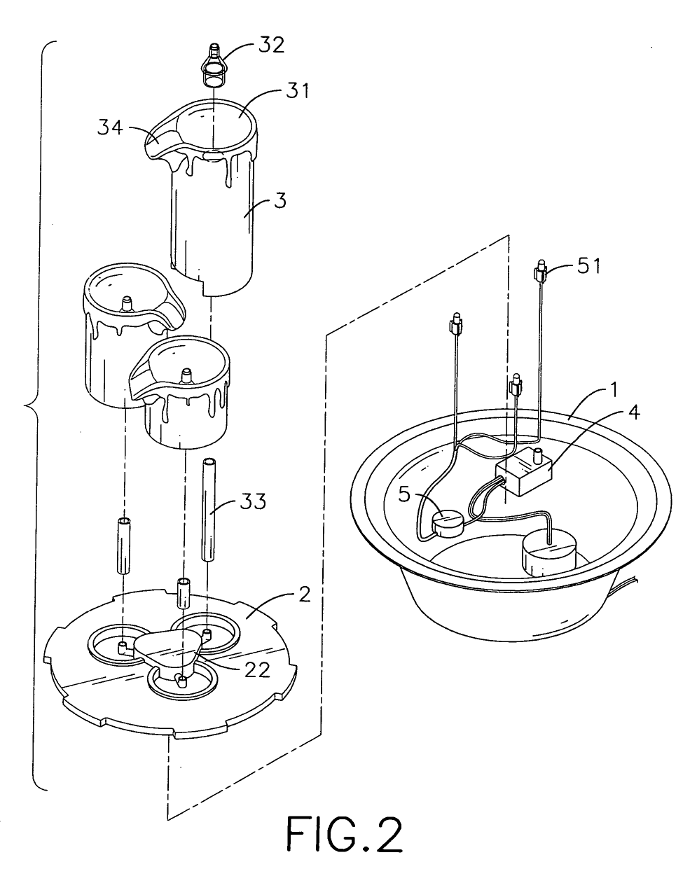

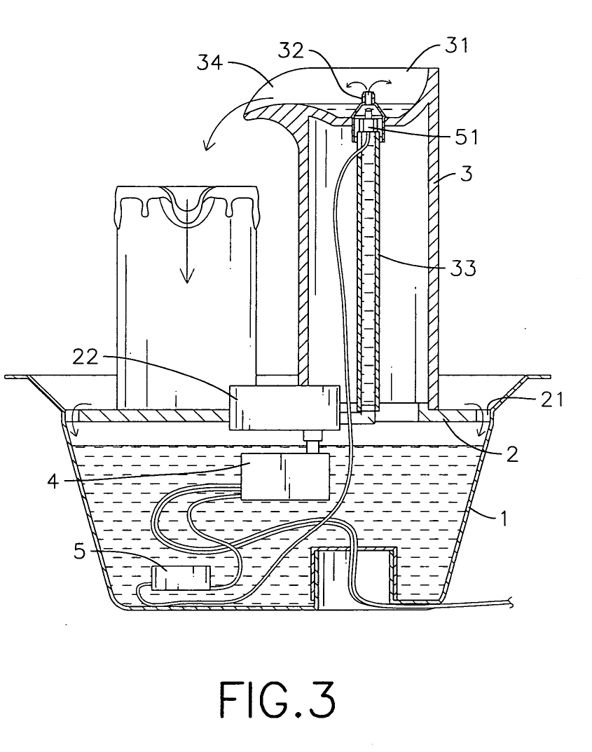

With reference to FIGS. 1, 2 and 3, a fountain in accordance with the present invention comprises a base (1), an optional cover (2), at least one stand (3), a pump (4) and a lighting assembly (5).

The base (1) is hollow and has a top opening and a liquid recess. The liquid recess is formed inside the base (1) and holds a liquid.

The cover (2) is mounted on the top opening of the base (1) and has a side edge, a top surface, multiple cutouts (21) and a tube connector (22). The cutouts (21) are formed in the side edge of the cover (2). The tube connector (22) is mounted on the cover (2) and has an inlet and at least one outlet. The outlet communicates with the inlet.

Multiple stands (3), for example three stands (3), having different heights may be used. Each stand (3) is mounted in the top opening of the base (1) above the liquid recess, may be mounted on the top surface of the cover (2), may be shaped like a candle and has a top, a top liquid recess (31), a tube cavity, a nozzle (32) and a tube (33).

The top liquid recess (31) is formed in the top of the stand (3) and has a bottom, a side edge, a through hole and a spout (34). The through hole is formed through the bottom of the top liquid recess (31). The spout (34) is formed at the side edge of the top liquid recess (31).

The tube cavity is formed inside the stand (3).

The nozzle (32) is mounted in the through hole in the top liquid recess (31) and extends upward.

The tube (33) is mounted in the tube cavity in the stand (3) and has a top end and a bottom end. The top end of the pipe (33) is connected to the nozzle (32). The bottom end of the pipe (33) is connected to the outlet of the tube connector (22).

The pump (4) is mounted in the liquid recess of the base (1), communicates with the bottom end of the tube and may be connected to the inlet of the tube connector (22). The pump (4) may be battery powered or powered by an external power source.

The lighting assembly (5) is connected electrically to the pump (4) and has at least one light emitting device (51). The light emitting device (51) is waterproof and mounted between the nozzle (32) and the top end of the tube (33). The emitting device (51) may be a light-emitting diode (LED), an incandescent lamp, a halogen lamp or any device that is able to emit light.

The liquid in the liquid recess of the base (1) is pumped by the pump (4) through the tube connector (22) and the tube (33) to the top liquid recess (31) of the stand (3). When the liquid passes through the nozzle (32), the liquid will gush upward and will fall back into the liquid being discharged from the nozzle (32) into the top liquid recess (31) of the stand (3). Light from the lighting device (5) makes the liquid look like a candle flame.

By aligning the spout (34) of taller stands with the top liquid recess (31) in subsequently shorter stands (3), the liquid in the top liquid recesses (31) flows to subsequently lower top liquid recesses (31) before flowing onto the cover (2) and draining through the cutouts (21) in the cover (2) back into the liquid recess in the base (1). The pump (4) continuously recycles the liquid back to the nozzles (32). The liquid flows from each stand (3) and carries the light much like an optical fiber.

Because the lighting device (5) replaces the candle, the fountain is safer to use and easy to operate. Furthermore, the fountain can be used outside, and the light assembly (5) will not be effected by the environment.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A fountain comprising
a base being hollow and having
a top opening; and
a liquid recess formed inside of the base for holding liquid;
at least one stand mounted in top opening of the base above the liquid recess, and each one of the at least one stand having
a top;
a top liquid recess formed on the top of the stand and having
a bottom;
a side edge;
a through hole formed through the bottom of the top liquid recess; and
a spout formed at the side edge of the top liquid recess;
a tube cavity formed inside the stand;
a nozzle mounted in the through hole in the top liquid recess and extending upward; and
a tube mounted in the tube cavity of the stand and having
a top end connected to the nozzle; and
a bottom end;
a pump mounted in the liquid recess of the base and communicating with the bottom end of the tube of one of the at least one stand; and
a lighting assembly connected electrically to the pump and having
at least one light emitting device being waterproof and mounted between the nozzle and the top end of the tube of the at least one stand in respective;
whereby the liquid flows and light from the lighting assembly creates an illusion of a candle flame.

2. The fountain as claimed in claim 1 further comprising
a cover mounted on the top opening of the base and having
a side edge;
a top surface;
multiple cutouts formed in the side edge of the cover; and
a tube connector mounted on the cover and having
an inlet; and
at least one outlet communicating with the inlet;
whereby the at least one stand is mounted on the top surface of the cover, the bottom end of the tube of the at least one stand is connected respectively to the at least one outlet of the tube connector and the pump is connected to the inlet of the tube connector.

3. The fountain as claimed in claim 1, wherein the at least one light emitting device is a light-emitting diode.

4. The fountain as claimed in claim 1, wherein the at least one light emitting device is an incandescent lamp.

5. The fountain as claimed in claim 1, wherein the at least one light emitting device is a halogens lamp.
